(19) United States
(12) Patent Application Publication
(10) Pub. No.: US 2007/0200881 A1
(43) Pub. Date: Aug. 30, 2007

(54) Height adjustment system for image forming machine

(76) Inventors: NamJeon Park, Anyang-si (KR); YunJoo Moon, Sungnam-si (KR); DongMin Kim, Seoul (KR); JungMi Oh, Seoul (KR); ByungChul Kyun, Uiwang-si (KR); SoonJae Moon, Kwangmyung-si (KR); JunHo Lee, Anyang-si (KR)

Correspondence Address: KIMBERLY-CLARK WORLDWIDE, INC., 401 NORTH LAKE STREET, NEENAH, WI, 54956, US

(21) Appl. No.: 11/362,298

(22) Filed: Feb. 24, 2006

(51) Int. Cl. B41J 25/308

(52) U.S. Cl. 347/8

(57) ABSTRACT

There is provided a feeding system for an image forming machine using a first feeder roll and a press roll that form a nip between them though which a substrate is passed, and a second feeder roll located after a printing zone, where the first and second feeder rolls move at the same speed.

### BACKGROUND OF THE INVENTION

Wide format image forming machines are used for printing complex patterns on various substrates like paper, films, nonwoven fabrics, woven cotton, canvas, silk, polyester, nylon, Lycra® and other materials. These printers or image forming machines are capable of producing images on substrates having widths of greater than about 36 inches (910 mm) at relatively high speeds. Such large scale applications include the creation of images on mattress covers and bedspreads, automotive fabrics, upholstery, architectural applications, signs and banners and the like.

Wide format image forming machines generally have a plurality of printing heads mounted above the substrate and move across the substrate, perpendicular to the direction of motion of the substrate. As the printing heads move from side to side across the substrate, they deposit colorant to form an image in a predetermined pattern, conventionally controlled by a computer system.

The shear size of the image forming machine used in wide-width printing presents the user with a variety of technical problems. Existing substrate feeding systems, for example, can result in substrate stretching, misalignment, wrinkling, and colorant bleeding as the substrate is feed over plates and between pinch rolls during the printing process. Improper drying of the substrate can result in smearing of the colorant on the substrate or on parts of the image forming machine. In addition, current systems also have difficulty in adapting to substrates of varying thicknesses. Current image forming machines are able to adapt to variations in substrate thickness of up to about 1 mm from the machine's built in or pre-set thickness capability because the printing head is moved vertically to accommodate thicker substrates while the balance of the machine is held stationary, and the range of this movement is limited.

The complexity of these image forming machines presents another challenge to the designer as modifications and changes to existing systems must be capable of fitting into relatively small spaces. In addition, certain types of printing heads are quite fragile and must be treated with the utmost care lest they be damaged. The close tolerances required in the making of such machines allow for the creation of high quality images, but make successful modification of the machine quite difficult.

It is an object of this invention to provide an image forming system that allows for producing images on relatively thicker substrates in a manner which does not involve the movement of the printing head unit.

### BRIEF DESCRIPTION OF THE FIGURES

FIG. 1 is a side view diagram of an image forming machine having the height adjustment system of this invention.

FIG. 2 is a rear view of the height adjustment system of this invention.

### SUMMARY OF THE INVENTION

The inventors have found that vertically adjusting the height of the continuous substrate feeding system instead of moving the printing head unit, allows for a greater range of adjustment with less opportunity to damage the printing head unit. This allows for a wider range of substrates of much greater thickness to be printed upon.

Other features and aspects of the present invention are discussed in greater detail below.

### DETAILED DESCRIPTION

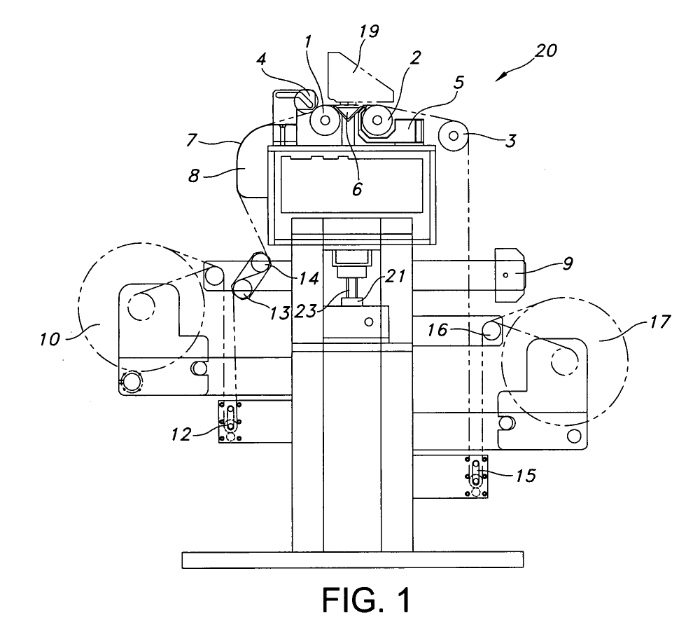

Turning to FIG. 1 one can see that the substrate feeding system 20 of the image forming machine includes at least two feeder rolls (1, 2) and a third feeder roll 3, as well as a press roll 4 arranged around an ink tray 6 located in the printing zone. The printing zone is the area where the printing head unit 19 travels perpendicularly to the direction of movement of the substrate (the machine direction or MD). FIG. 1 shows the invention in the X and Y planes and the movement of the printing head is in the Z direction (the cross-machine direction or CD). The printing head unit is mounted to a frame support system (not shown) which is independent of the support for the substrate feeder system.

The substrate 7 is taken from a supply roll 10 around various guide rollers 11 and around a rack and pinion roll 12, though this may vary based on the needs of the user. The rack and pinion roll 12 serves as one means of controlling tension by moving vertically as needed in response to the tension sensed in the substrate. From the rack and pinion roll 12 the substrate may pass between a pair of tension rolls 13, 14 which not only rotate individually but may rotate as a pair about a common axis in order to provide an additional means of controlling the substrate tension.

Upon leaving the tension rolls 13, 14 the substrate 7 may pass around a rounded plate 8 and into the pinch or nip between the driven first feeder roll 1 and the un-driven press roll 4. Since the press roll 4 is un-driven, it moves only because of friction with the substrate 7 which is moved by the driven feeder rolls. As the substrate 7 moves from left to right in FIG. 1, it then passes into the printing zone; the location of the ink tray 6 as mentioned above, and on to the second feeder roll 2, which is also driven. The substrate is printed in the printing zone. As the substrate 7 moves, heated air may be directed upward toward the substrate 7 from the dryer 5 to dry the colorant sufficiently. After passing over the second feeder roll 2 the substrate 7 passes above the dryer 5 and to the third feeder roll 3.

The substrate 7 may move directly from the second feeder roll to a wind-up operation or the third feeder roll 3, if present, may send the substrate 7 to the wind-up operation which may vary depending on the needs of the user. As shown in FIG. 1, the substrate 7 passes near an infrared heater 9 to finish the drying step completely and then passes another tension controlling rack and pinion roll 15 and around another guide bar 16 before going to a take-up roll 17.

The above description of a feeding system is a general representation of wide format printing and is not meant to limit the scope of the invention in any way. The height adjustment system of the current invention will function with a variety of feeding systems.

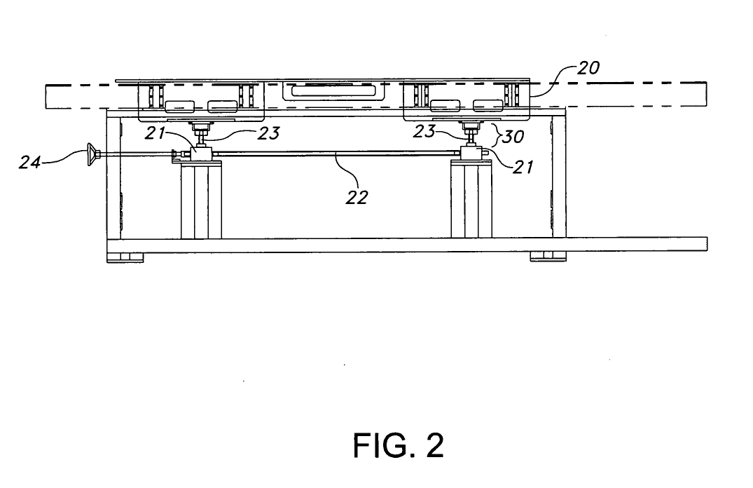

Turning to FIG. 2, the height adjustment system 30 may be seen below the feeding system 20. The height adjustment system has at least one and desirably two screw jacks 21 mounted below and supporting the weight of the feeding system 20. The screw jacks 21 are connected by a shaft 22 which is connected by conventional ninety degree gearing to the screw 23 of the screw jacks 21. When the shaft 22 is turned, its movement is translated into simultaneous vertical movement by the screw jacks 21, thus moving the feeding system 20 up or down while maintaining the separately mounted printing head unit 19 in the same position. Assuming both screws 23 have the same degree of thread angle or gearing, both will move the same distance vertically. One or both ends of the shaft 22 may have a handle 24 to aid in turning the shaft, which may also be motorized. A number of these features are also visible in FIG. 1.

When the handle 24 is turned, the screw jacks 21 will move the feeding system 20 up or down. Since the printing head unit 19 is mounted independently of the feed system 20, the distance between the printing head unit 19 and feeding system 20 will vary as the feeding system 20 moves vertically. The gap between the printing head unit 19 and the feeding system 20 is the thickness of the substrate which may be printed upon and may be varied over a very wide range, dependent only upon the physical constraints of the screw jacks 21. In practice, however, the inventors have found that a limit of substrate thickness of about 12 mm is the maximum necessary.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A height adjustment system for an image forming machine comprising a printing head unit above a continuous substrate feeder system and at least one jack screw mounted below said substrate feeder system, wherein said jack screw can raise and lower said feeder system independently of said printing head unit.

2. The system of claim 1 comprising two jack screws connected by gears to a shaft, the turning of said shaft causing both jack screws to move the same distance.

3. The system of claim 1 wherein said printing head unit and said substrate feeder system may be separated by from 0.5 to 12 mm.
